(19) United States
(12) Patent Application Publication
(10) Pub. No.: US 2016/0188986 A1
(43) Pub. Date: Jun. 30, 2016

(54) DETECTION SYSTEM AND DETECTION METHOD

(71) Applicant: FUJITSU LIMITED, Kawasaki-shi (JP)

(72) Inventors: Yasuhiro AOKI, Kawasaki (JP); Masami Mizutani, Kawasaki (JP)

(73) Assignee: FUJITSU LIMITED, KAWASAKI (JP)

(21) Appl. No.: 14/937,120

(22) Filed: Nov. 10, 2015

(30) Foreign Application Priority Data
Dec. 25, 2014 (JP) 2014-263358

(51) Int. Cl. G06K 9/00; G06T 7/00; H04N 5/232

(52) U.S. Cl. CPC G06K 9/00805; H04N 5/23229; G06T 7/004; G06T 2207/10004; G06T 2207/30261

(57) ABSTRACT

A detection system that detects a three-dimensional object on a reference surface, the detection system includes: a ranging device configured to measure a distance and a direction to an object including the three-dimensional object; and a processor configured to obtain ranging data from the ranging device, the ranging data being an aggregation of three-dimensional points indicating a position of the object, which are defined from the distance and the direction, calculate, based on the ranging data, a change amount in a height direction between a first point from among the aggregation of three-dimensional points and each of surrounding points of the first point, determine whether the first point is included in one or more points corresponding to the three-dimensional object, based on a difference between the change amounts, and output a result of a determination.

### CROSS-REFERENCE TO RELATED APPLICATION

This application is based upon and claims the benefit of priority of the prior Japanese Patent Application No. 2014-263358, filed on Dec. 25, 2014, the entire contents of which are incorporated herein by reference.

### FIELD

The embodiments discussed herein are related to a technology by which a three-dimensional object is detected.

### BACKGROUND

There is a technology by which an obstacle that exists in the periphery of a vehicle is detected. As a technology in the related art, a technology has been proposed by which a delineator group and a two-wheeled vehicle that travels near the delineator group are distinguished by determining the delineator group using a point that an obstacle is allowed to be recognized in its height direction. In addition, a technology has been proposed by which a road surface and a three-dimensional object are determined by generating a grid map in which a three-dimensional distance data point cloud measured by laser radar is accumulated. For example, the technologies in the related art are discussed in Japanese Laid-open Patent Publication No. 2001-283392 and Japanese Laid-open Patent Publication No. 2013-140515.

### SUMMARY

According to an aspect of the invention, a detection system that detects a three-dimensional object on a reference surface, the detection system includes: a ranging device configured to measure a distance and a direction to an object including the three-dimensional object; and a processor configured to obtain ranging data from the ranging device, the ranging data being an aggregation of three-dimensional points indicating a position of the object, which are defined from the distance and the direction, calculate, based on the ranging data, a change amount in a height direction between a first point from among the aggregation of three-dimensional points and each of surrounding points of the first point, determine whether the first point is included in one or more points corresponding to the three-dimensional object, based on a difference between the change amounts, and output a result of a determination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a vehicle;

FIG. 2 is a functional block diagram illustrating an example of a three-dimensional object detection device;

FIG. 3 is a diagram illustrating a first example of coordinates of a LIDAR coordinate system;

FIG. 4 is a diagram illustrating an example in which the coordinate system in FIG. 3 is replaced by a vehicle coordinate system;

FIG. 5 is a flowchart illustrating an example of determination processing;

FIG. 6 is a diagram illustrating a second example of coordinates of the LIDAR coordinate system;

FIGS. 7A and 7B are diagrams illustrating examples of height change amounts;

FIG. 8 is a flowchart illustrating an example of display processing;

FIG. 9 is a diagram illustrating an example of a video of a vehicle;

FIG. 10 is a diagram illustrating a first example of a video displayed on a monitor;

FIG. 11 is a flowchart illustrating an example of display processing in a modification 1;

FIG. 12 is a diagram illustrating a second example of a video displayed on the monitor;

FIG. 13 is a diagram illustrating a third example of a video displayed on the monitor;

FIG. 14 is a flowchart illustrating an example of warning processing in a modification 2; and

FIG. 15 is a diagram illustrating an example of a hardware configuration of the three-dimensional object detection device.

### DESCRIPTION OF EMBODIMENTS

In the above-described technology, it is difficult to detect a low-height three-dimensional object. For example, when an obstacle is recognized in the height direction, it is difficult to distinguish a slope having a gradient to some extent and a low-height three-dimensional object. In addition, in a case in which a grid map is utilized, when the height of the three-dimensional object is low, the distribution in the height direction become small in a cell, so that there is a possibility that the three-dimensional object may be detected as a road surface.

An object of an embodiment is to detect a three-dimensional object even when the height of the three-dimensional object is low.

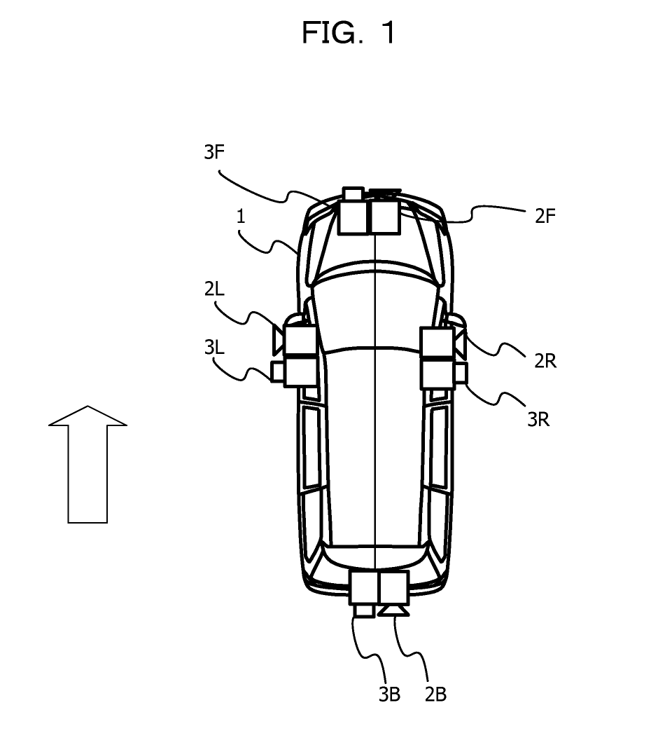

The embodiments are described below with reference to the drawings. FIG. 1 is a diagram illustrating an example of a vehicle 1. The vehicle 1 according to an embodiment is, for example, an automobile. In addition, the vehicle 1 may be a vehicle other than an automobile. For example, the vehicle 1 may be a delivery vehicle such as a dump truck. Hereinafter, the vehicle 1 may be referred to as the vehicle.

In addition, the three-dimensional object detection device according to the embodiment detects a three-dimensional object. The three-dimensional object is an object that protrudes upward from a road surface in the vertical direction. The three-dimensional object detection device detects a three-dimensional object appropriately even when the height of the three-dimensional object is low. There is, as an example of the three-dimensional object, a curb or the like the height of which is about 10 cm. The three-dimensional object detection device according to the embodiment also detects a high-height three-dimensional object.

The three-dimensional object detection device according to the embodiment is applied, for example, to parking assistance of the vehicle 1. A plurality of structural objects exists in a parking lot, and even a low-height structural object (three-dimensional object) exists from among the plurality of structural objects. In this case, the three-dimensional object detection device detects the low-height structural object, and causes a driver of the vehicle 1 to recognize the detected structural object, so that the parking assistance for the driver is achieved.

<Example of the Vehicle>

In the example of FIG. 1, the arrow faces the forward direction of the vehicle 1. When the forward direction indicated by the arrow of the example of FIG. 1 is defined as a reference, the opposite direction is defined as a backward direction, the direction to the left side of the vehicle is defined as a left direction, and the direction to the right side of the vehicle is defined as the right direction. As illustrated in the example of FIG. 1, the vehicle 1 includes a camera 2F that covers the forward direction of the vehicle 1, a camera 2B that covers the backward direction, a camera 2L that covers the left direction, and a camera 2R that covers the right direction.

Hereinafter, the cameras 2F, 2B, 2L, and 2R may be referred to as a camera 2. In the embodiment, the camera 2 captures a video downward from the horizontal plane direction. In this case, the video captured by each camera 2 is converted into an image whose view point was converted from upward to downward. In addition, a bird's eye image in which the vehicle 1 is looked down from above is obtained by combining the converted images of the videos that respectively have been captured by each camera 2.

In the embodiment, the video of the vehicle 1 is not limited to the bird's eye image. For example, each camera 2 may capture an image in the horizontal direction. In this case, a video of the periphery of the vehicle 1 is obtained. The number of the camera 2 installed in the vehicle 1 may not be four, and may be a certain quantity. For example, a single whole-sky camera may be installed on the top of the vehicle 1.

In addition, a video not of the entire periphery of the vehicle 1 but of a part of the periphery may be obtained. For example, merely a video of the backward direction of the vehicle 1, which is a blind spot for a driver who drives the vehicle 1, may be captured. In this case, merely the camera 2B that covers the backward direction may be installed in the vehicle 1.

As illustrated in the example of FIG. 1, the vehicle 1 includes a ranging device 3F that performs ranging for the environment of the forward direction, a ranging device 3B that performs ranging for the environment of the backward direction, a ranging device 3L that performs ranging for the environment of the left direction, and a ranging device 3R that performs ranging for the environment of the right direction. Hereinafter, the ranging devices 3F, 3B, 3L, and 3R may be collectively referred to as ranging device 3.

The ranging device 3 is a device that performs measurement of a distance. In the embodiment, it is assumed that each ranging device 3 corresponds to light detection and ranging (LIDAR). The ranging device is not limited to the LIDAR. For example, the ranging device may correspond to a millimeter-wave radar or the like.

In the embodiment, four of the ranging device 3 perform ranging for the entire periphery of the vehicle. However, the number of ranging device 3 installed in the vehicle 1 is not limited to four. For example, a rotatable ranging device 3 may be installed on the top of the vehicle 1. That is, the ranging device 3 may rotate so as to range the entire periphery of the vehicle 1.

<Example of the Three-Dimensional Object Detection Device>

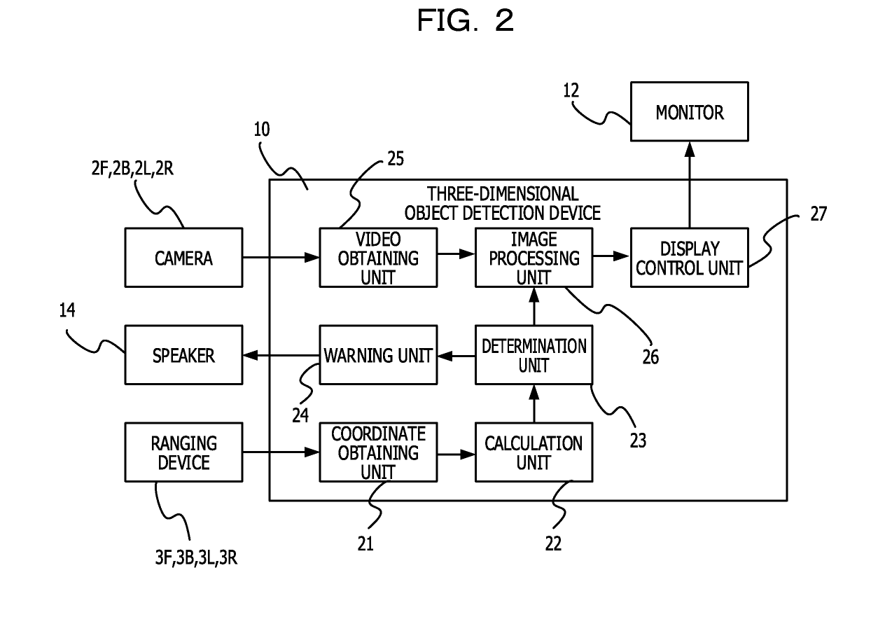

An example of the three-dimensional object detection device 10 is described below with reference to FIG. 2. The camera 2 (2F, 2B, 2L, and 2R) and the ranging device 3 (3F, 3B, 3L, and 3R), a monitor 12, and a speaker 14 are coupled to the three-dimensional object detection device 10.

The monitor 12 is a display device. For example, the monitor 12 may be a screen of a car navigation provided in the vicinity of the driver's sheet of the vehicle 1. The speaker 14 emits warning sound. The speaker 14 may be, for example, a speaker of a car stereo provided in the vehicle 1.

The three-dimensional object detection device 10 includes a coordinate obtaining unit 21, a calculation unit 22, a determination unit 23, a warning unit 24, a video obtaining unit 25, an image processing unit 26, and a display control unit 27. The function of the three-dimensional object detection device 10 is not limited to the example of FIG. 2.

Each ranging device 3 performs ranging for an environment within a certain range, as a three-dimensional point cloud. As a result, each ranging device 3 obtains a two-dimensional distance image. Coordinates of the three-dimensional point cloud in the distance image includes a ranging value in the measurement direction.

The coordinate obtaining unit 21 obtains coordinates of a specified point that is a determination target and a plurality of points in the periphery of the specified point, in the three-dimensional point cloud of the distance image. At this time, the coordinates of the specified point and the coordinates of the plurality of points in the periphery of the specified point, which are obtained by the coordinate obtaining unit 21, are three-dimensional coordinates using a LIDAR coordinate system as a reference. The three-dimensional coordinate is obtained based on the ranging value and the measurement direction in which the ranging device 3 has performed measurement.

The calculation unit 22 executes various calculations using the coordinates that have been obtained by the coordinate obtaining unit 21. The ranging data obtained by the ranging device 3 includes the three-dimensional point cloud. The determination unit 23 defines each point in the three-dimensional point as a specified point and determines whether the specified point belongs to a three-dimensional object.

When the specified point does not belong to the three-dimensional object, the determination unit 23 determines that the specified point belongs to a road surface. It does not matter whether the road surface is a horizontal plane or a slope. The determination unit 23 determines whether each of the specified points of the three-dimensional point cloud included in the ranging data belongs to the three-dimensional object or the road surface. Therefore, the determination unit 23 has a function as a classification unit that sorts each of the points of the three-dimensional point cloud into the three-dimensional object or the road surface.

The warning unit 24 controls the speaker 14 to emit a warning sound, based on a positional relationship between the specified point that has been determined to belong to the three-dimensional object by the determination unit 23 and the vehicle. The warning unit 24 may change the volume of the warning sound in stages, based on the positional relationship between the specified point and the vehicle.

The video obtaining unit 25 obtains a video captured by each camera 2. As described above, in the embodiment, four of the camera 2 that respectively covers the forward direction, the backward direction, the left direction, and the right direction are installed in the vehicle 1. The video obtaining unit 25 obtains the videos that respectively have captured by four of the camera 2.

The image processing unit 26 executes image processing in which a bird's eye image including the vehicle 1 is generated based on the obtained four videos. As described above, the video including the vehicle 1 may not be the bird's eye image. For example, the image processing unit 26 may execute the image processing for an image of the periphery captured in the horizontal direction by four of the camera 2.

The image processing unit 26 executes processing in which it is clearly specified that the portion of the specified point that has been determined to belong to the three-dimensional object by the determination unit 23 in the bird's eye image corresponds to the three-dimensional object. For example, the image processing unit 26 may execute processing in which the specified point that has been determined to belong to the three-dimensional object in the bird's eye image is sterically displayed.

In addition, the image processing unit 26 may perform light-emitting display, emphasis display, or the like, for the specified point that has been determined to belong to the three-dimensional object. When the emphasis display is performed, the image processing unit 26 may change the state of the emphasis display, based on the positional relationship between the vehicle 1 and the specified point.

For example, the image processing unit 26 may increase the emphasis of the display of the specified point when a distance between the vehicle 1 and the specified point is near, and may reduce the emphasis of the display of the specified point when the distance between the vehicle 1 and the specified point is far.

The display control unit 27 displays the video that has been subjected to the image processing by the image processing unit 26, on the monitor 12. In the embodiment, it is assumed that the video displayed on the monitor 12 is a movie based on the videos captured by each camera 2. However, the video displayed on the monitor 12 may be a still image at a certain time.

<LIDAR Coordinate System and Vehicle Coordinate System>

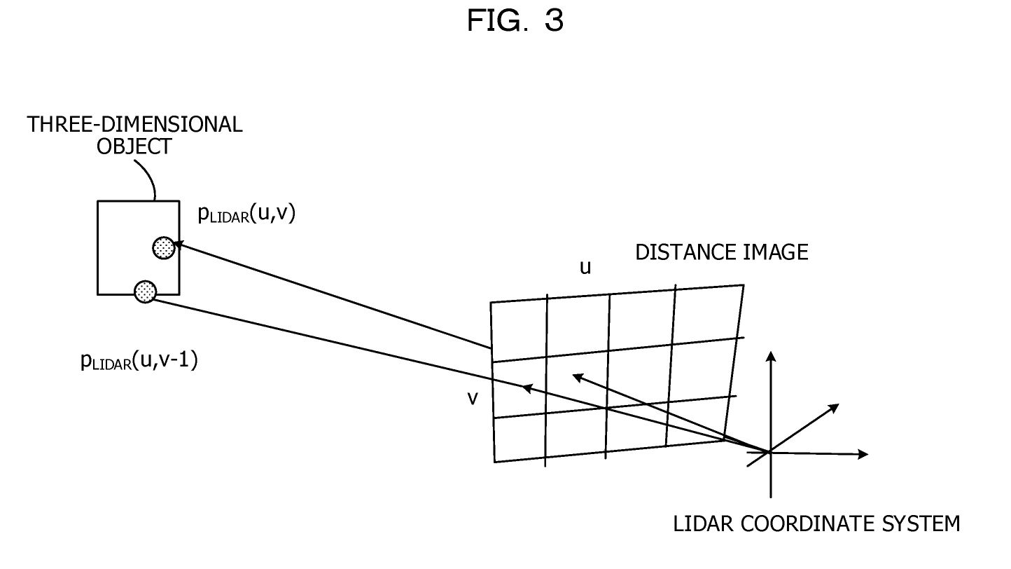

FIG. 3 is a diagram illustrating an example of two points in the three-dimensional object of the LIDAR coordinate system. A coordinate of a point in the LIDAR coordinate system in the embodiment is indicated as “p_{LIDAR}(u,v)”. In the example of FIG. 3, for the ranging device 3, “p_{LIDAR}(u,v)” and “p_{LIDAR}(u,v−1)” are points adjacent to each other in the distance image of the two axes of the u axis and the v axis.

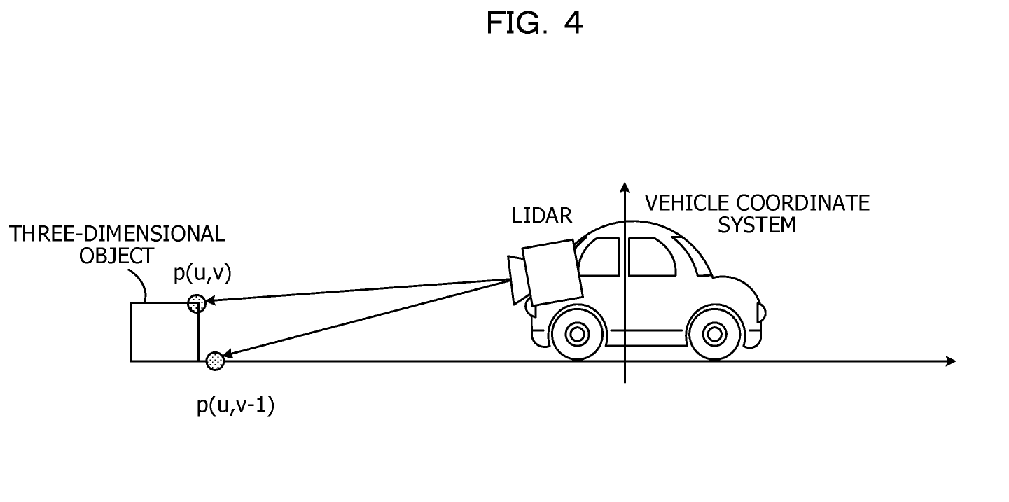

FIG. 4 is a diagram illustrating an example in which the LIDAR coordinate system of FIG. 3 is replaced by a vehicle coordinate system. The vehicle coordinate system is a coordinate system set for the vehicle 1, and for example, the vertical direction that passes through the center of the vehicle 1 is defined as the positive direction of the Z axis. In addition, when the contact point of the Z axis with the road surface is defined as the origin point, the contact surface may be defined as an XY plane. For example, the X axis may be defined as the right direction of the vehicle 1, and the Y axis may be defined as the forward direction of the vehicle 1.

When the installation position of the ranging device 3 is represented as “T” and the posture of the ranging device 3 is represented as “R”, the LIDAR coordinate p_{LIDAR}(u,v) is transformed to a corresponding point p(u,v) in the vehicle coordinate system by the following formula (1). The coordinate obtaining unit 21 obtains the coordinates in the vehicle coordinate system by which the LIDAR coordinate system has been replaced, based on the following formula (1).

p(u,v)=R×p_{LIDAR}(u,v)+T formula (1)

<Example of Processing in which it is Determined Whether a Specified Point Belongs to a Three-Dimensional Object>

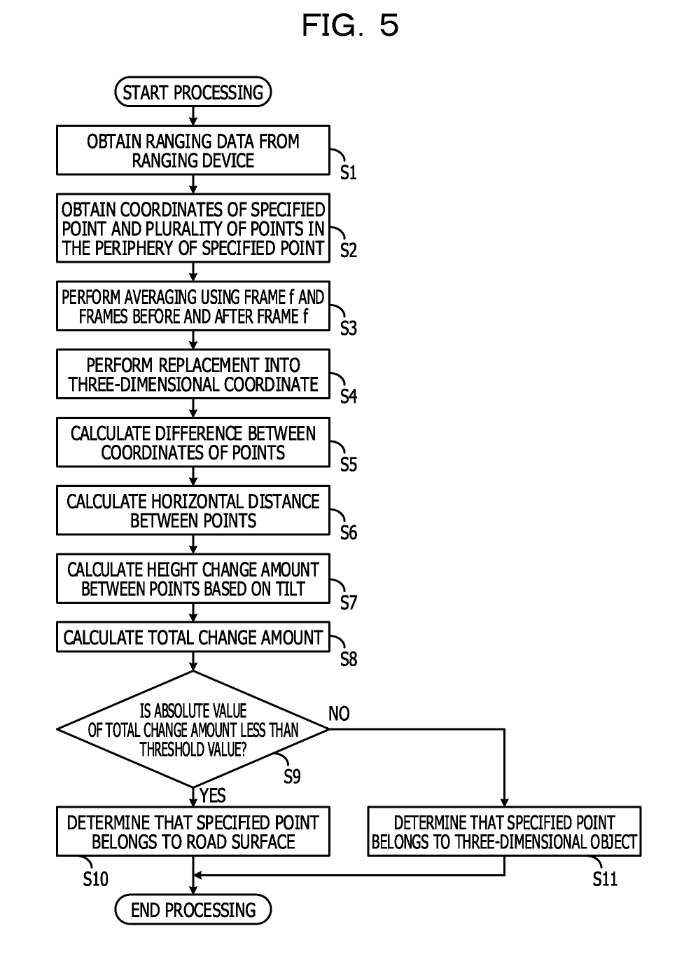

An example of the processing in which it is determined whether a specified point belongs to a three-dimensional object (determination processing) is described below with reference to the flowchart of FIG. 5. Each ranging device 3 performs ranging and obtains ranging data (Step S1). Each of the pieces of ranging data includes a distance image of a three-dimensional point cloud.

As described above, in the embodiment, the vehicle 1 includes the four ranging devices 3F, 3B, 3L, and 3R. Thus, each ranging device 3 obtains ranging data in a different ranging direction.

The ranging data obtained by each ranging device 3 is data including the three-dimensional point cloud. The coordinate obtaining unit 21 obtains the coordinates of a single specified point that is a determination target by the determination unit 23 and the coordinates of a plurality of points in the periphery of the specified point, in the three-dimensional point cloud (Step S2).

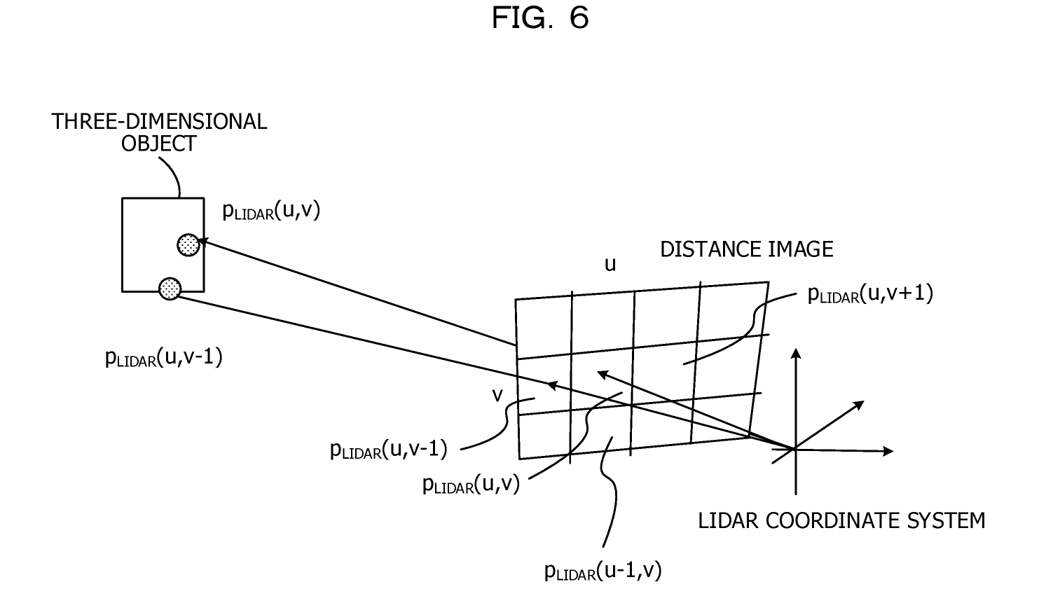

FIG. 6 is a diagram illustrating an example of the coordinates of four points in the periphery of a specified point when the specified point is the p_{LIDAR}(u,v). In the example of FIG. 6, the four points in the periphery of the specified point indicate points adjacent to the specified point in the vertical direction and the horizontal direction.

For example, it is assumed that the u axis of the distance image is the horizontal direction, and the v axis of the distance image is the vertical direction. In this case, the four points in the periphery of the specified point include two points adjacent to the specified point in the u axis direction and two points adjacent to the specified point in the v axis direction, on the u axis and the v axis of the distance image.

As illustrated in the example of FIG. 6, the four coordinates in the periphery of the specified point become p_{LIDAR}(u,v−1), p_{LIDAR}(u,v+1), p_{LIDAR}(u−1,v), and p_{LIDAR}(u+1,v). Thus, in the LIDAR coordinate system, each angle between the four points in the periphery of the specified point using the specified point as the center is at 90 degree.

The number of points in the periphery of the specified point is not limited to four. For example, the number of points in the periphery of the specified point may be two or eight. When the number of points in the periphery of the specified point is two, for example, two points adjacent to the specified point in the u axis direction or the v axis direction may be the points in the periphery of the specified point.

In addition, when the number of points in the periphery of the specified point is eight, for example, the points in the periphery of the specified point may be all points on the u axis and the v axis, which are adjacent to the specified point. The calculation unit 22 executes various calculations using the coordinates of the specified point and the coordinates of the points in the periphery of the specified point.

Thus, when the number of points to be calculated by the calculation unit 22 is large, the calculation amount of the calculation unit 22 is increased, so that the speed in which the detection result of the three-dimensional object is obtained is reduced. However, the detection of the three-dimensional object is performed based on many points, so that the detection accuracy is improved.

In addition, when the number of points to be calculated by the calculation unit 22 is small, the calculation amount of the calculation unit 22 is reduced, so that the speed in which the detection result of the three-dimensional object is obtained is increased. However, the detection of the three-dimensional object is performed based on few points, so that the detection accuracy is reduced. Therefore, in the embodiment, it is assumed that the number of points in the periphery of the specified point is four in order to achieve the detection accuracy to some extent, and obtain the detection result with high speed to some extent.

Here, the coordinate system illustrated in FIG. 6 is the LIDAR coordinate system, and the coordinates of the LIDAR coordinate system are coordinates based on the ranging value and the direction in which the ranging device 3 performs the ranging. Thus, the coordinates of the LIDAR coordinate system are not the same as the coordinate in the actual three-dimensional space. However, it is highly probable that adjacent points on the u axis and the v axis of the distance image are also adjacent even in the actual three-dimensional space.

The calculation unit 22 performs calculation using the coordinates of the coordinate system in the three-dimensional space, and the determination unit 23 determines whether a specified point belongs to a three-dimensional object. At this time, the determination unit 23 determines whether the specified point belongs to the three-dimensional object, based on the change in the height change amount between the specified point and the points close to the specified point.

Thus, it is desirable that the point used for the determination is adjacent to the specified point. Thus, the coordinate obtaining unit 21 obtains the coordinates of the specified point and the four points adjacent to the specified point, even in the LIDAR coordinate system.

The coordinate obtaining unit 21 converts the coordinates of the specified point and the four points in the periphery of the specified point from the LIDAR coordinate system to the vehicle coordinate system, using the above-described formula (1). As a result, the specified point p_{LIDAR}(u,v) in the LIDAR coordinate system becomes the p(u,v) in the vehicle coordinate system. In addition, the coordinates of the points in the periphery of the specified point respectively become p(u,v−1), p(u,v+1), p(u−1,v), and p(u+1,v).

The ranging device 3 performs ranging at certain intervals. Therefore, the coordinate obtaining unit 21 obtains a distance image including a three-dimensional point cloud from each ranging device 3 at a certain frame rate. The coordinate obtaining unit 21 obtains the coordinates of the specified point and the four points in the periphery of the specified point in the above-described vehicle coordinate system, for each of the certain frame rates. In addition, the coordinate obtaining unit 21 outputs the coordinates of the specified point and the four points in the periphery of the specified point in the vehicle coordinate system, to the calculation unit 22, for each of the certain frame rates.

The calculation unit 22 performs various pieces of calculation, based on the coordinates of the specified point and the four points in the periphery of the specified point in the vehicle coordinate system, and the determination unit 23 determines whether the specified point belongs to a three-dimensional object, based on the calculation result of the calculation unit 22.

Therefore, it is desirable that the calculation unit 22 performs the various pieces of calculation, using not a single frame f, but a temporally successive plurality of frames. For example, it is possible that, in one incident of ranging, a light beam that has been emitted from the ranging device 3 is illuminated on a low-height three-dimensional object sparsely, so that the number of points that are not measured is increased.

In addition, there is a possibility that a measurement error is caused in the calculation based on the distance image obtained by one-incident of ranging. Therefore, it is desirable that the calculation unit 22 performs the calculation using the temporally successive frames.

Therefore, the calculation unit 22 calculates the coordinate (u,v) of the specified point p, using the following formula (2). In the following formula (2), the p(u,v,f−1) is the coordinates of the specified point before one frame from the frame f. Here, the p(u,v,f) is the coordinates of the specified point of the frame f. In addition, the p(u,v,f+1) is the coordinates of the specified point after one frame from the frame f.

p(u,v)=(p(u,v,f−1)+p(u,v,f)+p(u,v,f+1))/3 formula (2)

Thus, the calculation unit 22 averages the specified points in the vehicle coordinate system based on the frame f and the frames before and after the frame f (Step S3). Also, the calculation unit 22 performs the averaging, on the four points in the periphery of the specified point, using the formula (2).

The frame f and the frames before and after the frame f are temporally successive frames. When the frame rate is a short time period, it is considered that the change in the positional relationship between the vehicle and the three-dimensional object is small. Thus, a deviation due to the change in the positional relationship is absorbed by averaging the specified point and the four points in the periphery of the specified point in the frame f by the frames before and after the frame f. Thus, when the calculation unit 22 averages the coordinates of the specified point and the four points in the periphery of the specified point using the formula (2), the number of non-measured points that are described above is reduced, and the measurement error is reduced.

As described above, the calculation unit 22 performs the averaging using the formula (2). However, the method for reducing the number of non-measured points and reducing the measurement error is not limited to the above-described averaging. For example, it may be only sufficient to combine the coordinates of the specified point and the points in the periphery of the specified point of the temporally successive frames.

The coordinates of the specified point and the four coordinates in the periphery of the specified point, which have been averaged using the formula (2), are the coordinates of the vehicle coordinate system. The calculation unit 22 replaces the coordinates of the vehicle coordinate system by the coordinates of the three-dimensional space (three-dimensional coordinate) (Step S4). Hereinafter, it is assumed that the specified point is defined as p0, and the four points in the periphery of the specified point are respectively defined as p1 to p4 in order of close distances from p0.

The specified point p0 and the four points p1 to p4 in the periphery of the specified point p0 are indicated as follows. In the following description, “x”, “y”, and “z” indicate three-dimensional coordinates.

p0=p(u,v)=[x(u,v),y(u,v),z(u,v)]

p1=p(u+1,v)=[x(u+1,v),y(u+1,v),z(u+1,v)]

p2=p(u,v+1)=[x(u,v+1),y(u,v+1,z(u,v+1)]

p3=p(u,v−1)=[x(u,v−1),y(u,v−1),z(u,v−1)]

Each of the above-described formulas is represented by the following formula (3). Here, “pi” of the following formula (3) indicates “p1” to “p4”.

pi=[xi,yi,zi] formula (3)

Therefore, the specified point p0 and the four points p1 to p4 in the periphery of the specified point are represented by three-dimensional coordinates. After that, the calculation unit 22 calculates a difference between the coordinates of the specified point p0 and the coordinates of each of the four points p1 to p4 in the periphery of the specified point p0 (Step S5).

The difference between the coordinates is represented by the following formula (4).

Di=pi−p0=[Dxi,Dyi,Dzi]=[xi−x0,yi−y0,zi−z0] formula (4)

In the embodiment, the calculation unit 22 calculates “D1=p1−p0”, “D2=p2−p0”, “D3=p3−p0”, and “D4=p4−p0”. As a result, a difference between the coordinates of the specified point p0 and the coordinates of each of the four points p1 to p4 in the periphery of the specified point p0 is obtained.

After that, the calculation unit 22 calculates a horizontal distance between the specified point p0 and each of the four points p1 to p4 in the periphery of the specified point p0 (Step S6). The calculation of the horizontal distance is achieved by the following formula (5).

Li=\sqrt{(Dxi)²+(Dyi)²}=\sqrt{(xi−x0)²+(yi−y0)₂} formula (5)

A horizontal distance Li between the specified point p0 and each of the four points p1 to p4 in the periphery of the specified point p0 is obtained by the formula (5). That is, the respective distances Li such as a distance L1 between the p0 and the p1, a distance L2 between the p0 and the p2, a distance L3 between the p0 and p3, and a distance L4 between the p0 and p4 are obtained by the formula (5).

After that, the calculation unit 22 calculates a height change amount of each of the four points p1 to p4 in the periphery of the specified point p0 viewed from the specified point p0 (Step S7). The height change amount is described below. The height change amount is a difference of a height in the vertical direction in the three-dimensional space between the specified point p0 and each of the four points p1 to p4 in the periphery of the specified point p0.

Thus, the height change amount may be obtained by “zi−z0”. However, the coordinates zi and z0 are coordinates obtained by replacing the LIDAR coordinate system, which has been subjected to the ranging by the ranging device 3, with the three-dimensional coordinate. When the ranging device 3 performs the ranging, the distances between the ranging points may not be fixed. That is, the horizontal distance Li is different depending on the location at which the ranging device 3 performs the ranging.

Therefore, the calculation unit 22 defines a tilt of each of the four points p1 to p4 in the periphery of the specified point p0 viewed from the specified point p0, as the height change amount Ai. As a result, even in the case in which the horizontal distance Li is different depending on the location at which the ranging device 3 performs the ranging, the normalization is performed when the calculation unit 22 calculates the height change amount Ai using the tilt. In the three-dimensional coordinate on which the normalization has been performed, the distances between the ranging points become close to a fixed distance.

The calculation unit 22 calculates the height change amount Ai by the following formula (6).

$$Ai = \frac{Dzi}{Li} = \frac{Zi - Z 0}{\sqrt{{( xi - x 0 )}^{2} + {( yi - y 0 )}^{2}}} \qquad formula ( 6 )$$

As a result, the height change amount Ai of the four points p1 to p4 in the periphery of the specified point p0 viewed from p0 is obtained. The height change amount Ai indicates a change amount in each of the four points p1 to p4 in the periphery of the specified point p0 viewed from the specified point p0.

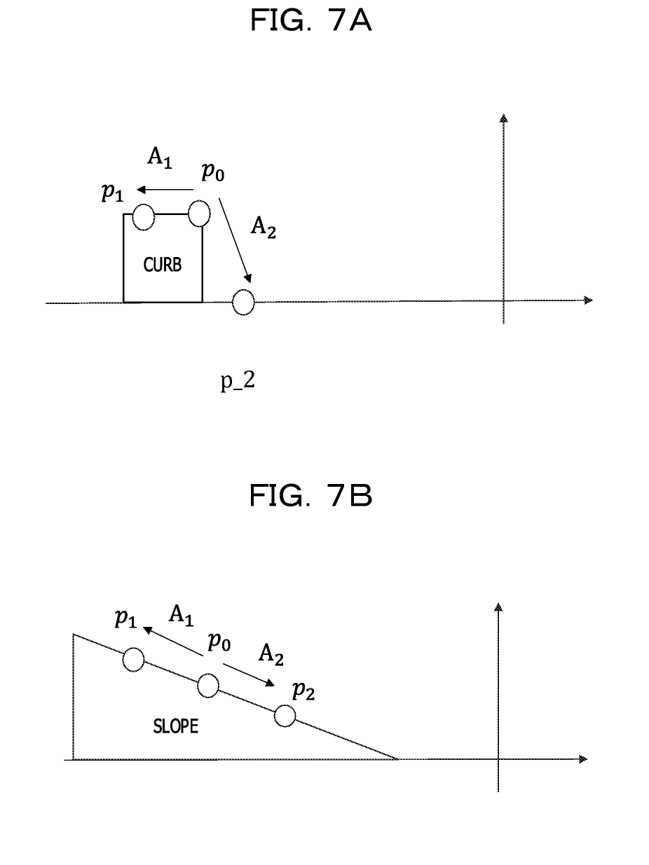

As the absolute value |Ai| of the height change amount Ai becomes smaller, a change in the height between the specified point p0 and the point pi becomes smaller. In addition, as the absolute value |Ai| of the height change amount Ai becomes larger, a change in the height between the specified point p0 and the point pi becomes larger. FIGS. 7A and 7B are diagrams illustrating examples of a height change amount Ai. In FIG. 7A, a curb is illustrated as an example of a three-dimensional object. It is assumed that the upper surface of the three-dimensional object has a plane. It is assumed that the center circle indicates the specified point p0, and the left circle indicates the point p1, and the right circle indicates the point p2, in the three circles in FIG. 7A. In addition, in FIG. 7A, the specified point p0 is a point on the three-dimensional object.

When the point p1 is a point on the same three-dimensional object as the p0, the specified point p0 has the substantially the same height as the point p1. Thus, the height change amount A1 between the specified point p0 and the point p1 becomes substantially zero. In addition, when the point p2 is a point on a road surface, an absolute value |A2| of the height change amount A2 between the specified point p0 and the p2 becomes a large value to some extent. Therefore, it is considered that the absolute values of the height change amounts A1 and A2 are greatly different from each other. That is, the absolute value is changed between the height change amounts A1 and the A2.

Thus, it is possible that the specified point p0 belongs to, for example, the three-dimensional object such as the curb. In addition, FIG. 7B is a diagram illustrating an example in which the specified point p0, the point p1, and the point p2 are on a slope. In the case of FIG. 7B, the symbols of the height change amount A1 between the specified point p0 and the point p1 and the height change amount A2 between the specified point p0 and the point p2 are inversed, but the absolute values of both of the height change amounts become large to some extent. However, a difference between the absolute value |A1| of the height change amount A1 and the absolute value |A2| of the height change amount A2 is small. Regardless whether the specified point is on a three-dimensional object or a slope, the absolute value of the height change amount between the specified point p0 and the point pi that is one of the four points in the periphery of the specified point p0 is large to some extent. Thus, in the embodiment, the determination unit 23 determines whether the specified point p0 belongs to the three-dimensional object, based on a difference in the height change amount (that is, change in the symbols and the state of the difference in the absolute value between the height change amounts Ai).

Therefore, the calculation unit 22 combines the height change amounts Ai between the specified point p0 and the respective four points in the periphery of the specified point p0 (Step S8). The calculation unit 22 performs calculation of the following formula (7).

$$V = {\sum }_{i} Ai \qquad formula ( 7 )$$

In the formula (7), “V” is a total change amount obtained by combining the height change amounts Ai between the specified point p0 and the respective four points in the periphery of the specified point p0. The calculation unit 22 outputs the calculated total change amount V to the determination unit 23. A threshold value th used to be compared with the total change amount V is set to the determination unit 23.

The determination unit 23 determines whether the absolute value |V| of the total change amount V is less than the threshold value th (Step S9). When the determination unit 23 determines that the absolute value |V| of the total change amount V is less than the threshold value th (YES in Step S9), the determination unit 23 determines that the specified point p0 belongs to a road surface (Step S10). In this case, the road surface may be a horizontal plane or a slope.

In addition, when the determination unit 23 determines that the absolute value |V| of the total change amount V is the threshold value th or more (NO in Step S9), the determination unit 23 determines that the specified point p0 belongs to a three-dimensional object (Step S11). When the determination unit 23 determines that the specified point p0 belongs to the three-dimensional object, the three-dimensional object detection device 10 detects the presence of the three-dimensional object.

Thus, even when the height of the three-dimensional object is low, the low-height three-dimensional object is detected. In addition, in Steps S10 and S11, the determination unit 23 sorts the specified point depending on whether the specified point belongs to the road surface or the three-dimensional object.

In the case of FIG. 7A, the height change amount A2 between the specified point p0 and the point p2 is approximately equal to the height of the three-dimensional object. The height change amount A2 viewed from the specified point p0 to the point p2 becomes a negative value. In addition, the height change amount A2 becomes a value that is large to some extent.

The specified point p0 and the point p1 are on the upper surface of the three-dimensional object, so that the height change amount A1 becomes approximately zero. Therefore, the absolute value |V| of the total change amount V becomes a value that is large to some extent. For example, in a case in which the vehicle 1 is an automobile, when an angle based on the height change amount A2 becomes more than 45 degree, the three-dimensional object becomes an obstacle for the automobile.

In this case, the threshold value th set to the determination unit 23 may be set at “1”. In the example of FIG. 7A, it is assumed that the angle based on the height change amount A2 is more than 45 degree. In this case, the absolute value |V| of the total change amount becomes “1” or more, which is the threshold value th, so that the determination unit 23 determines that the specified point p0 belongs to the three-dimensional object.

On the other hand, as illustrated in FIG. 7B, in the case of the slope, both of the height change amounts A1 and A2 become values that are large to some extent. The specified point p0, the point p1, and the point p2 are on the slope, so that the height change amount A1 becomes a positive value, and the height change amount A2 becomes a negative value. In addition, the specified point p0, the point p1, and the point p2 are on the slope, so that the absolute amounts of the height change amounts A1 and A2 are approximately the same.

Therefore, when the height change amounts A1 and A2 are combined in which the symbols are inversed, and the absolute amounts are approximately the same, the values are cancelled to each other, so that the absolute value |V| of the total change amount becomes approximately zero. Thus, the absolute value |V| of the total change amount V is less than the threshold value th, so that the determination unit 23 determines that the specified point p0 belongs to a road surface.

In addition, it is avoided that gentle unevenness formed on the road surface is determined as a three-dimensional object when the threshold value th is set at “1”. The gentle unevenness on the road surface does not become an obstacle for the vehicle 1, so that it is desirable that the determination unit 23 does not determine the unevenness as a three-dimensional object. In the gentle unevenness, the height change amount Ai is less than 45 degrees, so that the determination unit 23 may distinguish the gentle unevenness and a three-dimensional object when the threshold value th is set at “1”.

The absolute value |V| of the total change amount V is an absolute value of a value obtained by combining the height change amounts Ai of the specified point p0 and the respective four points in the periphery of the specified point p0. Therefore, the determination unit 23 determines whether the specified point p0 belongs to a three-dimensional object, based on a change in the height change amount Ai between the specified point p0 and each of the four points p1 to p4 in the periphery of the specified point p0.

Even when the height of a three-dimensional object is low, a difference is generated in the height change amount Ai between the specified point p0 and each of the four points p1 to p4 in the periphery of the specified point p0. Thus, even when the height of a three-dimensional object is low, the determination unit 23 may detect that the specified point p0 belongs to the low-height three-dimensional object, based on the difference in the height change amount Ai. As a result, the three-dimensional object detection device 10 may detect the low-height three-dimensional object.

In addition, in the case of the slope, a difference is generated in the height between two points along the slope from among the specified point p0 and the four points in the periphery of the specified point p0. However, the height change amount Ai is fixed, and a change is rarely generated in the height change amount Ai. Therefore, the three-dimensional object detection device 10 may distinguish a slope and a three-dimensional object.

The ranging data that has been ranged by the ranging device 3 includes a three-dimensional point cloud. Thus, the processing of the flowchart in the example of FIG. 5 is executed using each point of the three-dimensional point group included in the ranging data as a specified point. As a result, the determination is made as to whether or not each of the points of the three-dimensional point cloud belongs to a three-dimensional object.

<Example of Display Processing>

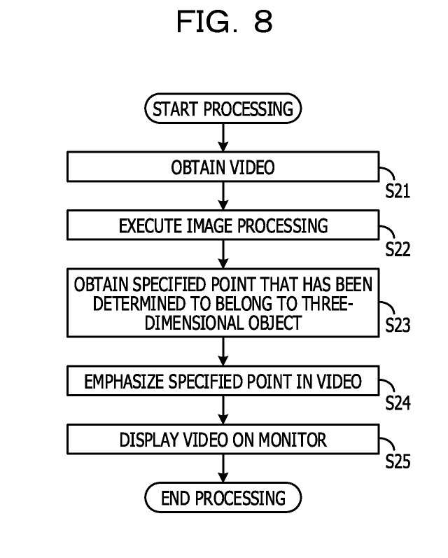

An example of display processing is described below with reference to the flowchart of FIG. 8. The video obtaining unit 25 obtains a video from four of the camera 2 (Step S21). It is assumed that the obtained videos are synchronized with each other.

The videos that have been obtained by the video obtaining unit 25 are input to the image processing unit 26, and the image processing unit 26 executes the image processing (Step S22). In the embodiment, the image processing unit 26 executes the image processing in which a bird's eye image is generated, based on the videos obtained from four of the camera 2.

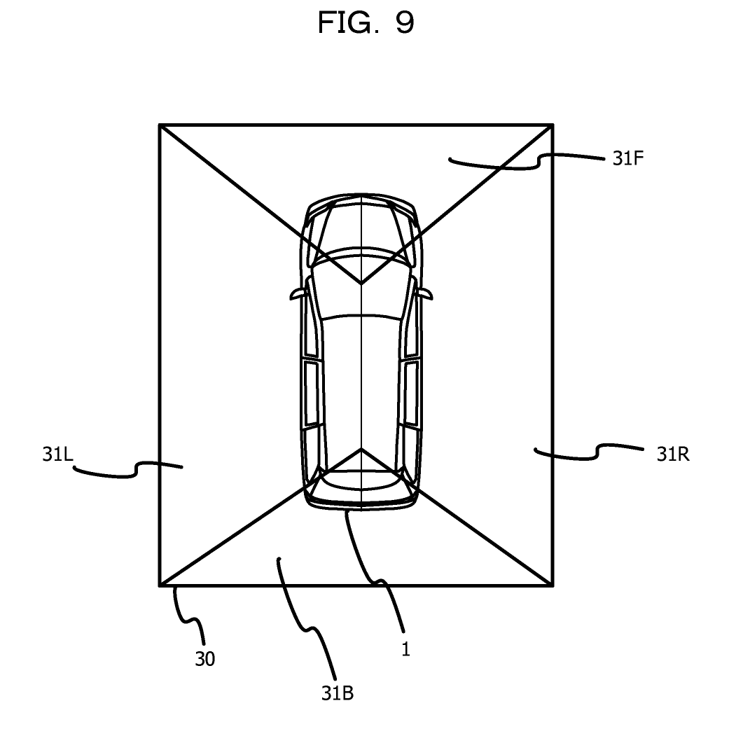

For example, as illustrated in FIG. 9, the image processing unit 26 generates a bird's eye image by combining the videos obtained from four of the camera 2. FIG. 9 is a diagram illustrating an example of a bird's eye image 30. In the bird's eye image 30, a front side area 31F corresponds to a video that has been captured by the camera 2F that covers the forward direction, a rear side area 31B corresponds to a video that has been captured by the camera 2B that covers the backward direction. A left side area 31L corresponds to a video that has been captured by the camera 2L that covers the left direction, and a right side area 31R corresponds to a video that has been captured by the camera 2R that covers the right direction.

The ranging data that the three-dimensional object detection device 10 obtains from the ranging device 3 includes a three-dimensional point cloud. The determination unit 23 defines each point of the three-dimensional point cloud as a specified point p0 and determines whether each of the specified points p0 of the three-dimensional point cloud belongs to a three-dimensional object. The image processing unit 26 obtains the specified point p0 that has been determined to belong to the three-dimensional object by the determination unit 23 (Step S23).

In Step S23, the image processing unit 26 executes processing in which the specified point p0 is emphasized in the video (bird's eye image) (Step S24). The posture and the positional relationship between the camera 2 and the ranging device 3 are known. Therefore, the image processing unit 26 may associate the video with the specified point p0.

It is considered that a plurality of points in the three-dimensional point cloud that has been measured by the ranging device 3 belongs to a three-dimensional object 40. Thus, when the image processing unit 26 emphasizes the plurality of points that belongs to the three-dimensional object 40, the three-dimensional object 40 in the video is emphasized.

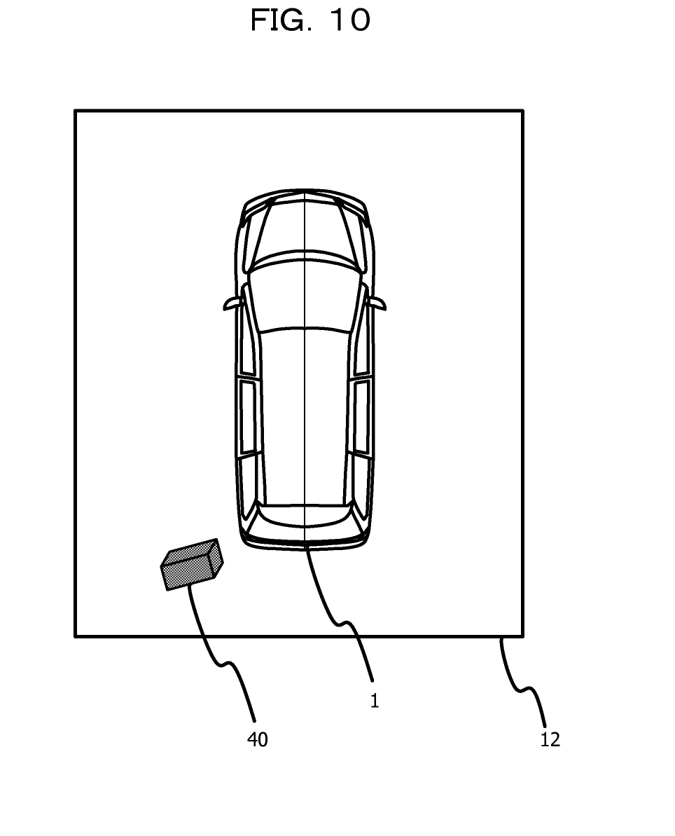

In addition, the image processing unit 26 outputs the video that has been subjected to the image processing, to the display control unit 27. The display control unit 27 causes the video illustrated in the example of FIG. 10 to be displayed on the monitor 12 by outputting the video to the monitor 12 (Step S25).

Thus, even a low-height three-dimensional object such as a curb is identified and displayed on the monitor 12, so that the driver of the vehicle 1 may visually recognize the low-height three-dimensional object by visually recognizing the monitor 12.

As described above, the three-dimensional object detection device 10 according to the embodiment may be applied, for example, to a case of assistance for the parking of the vehicle 1. When the vehicle 1 is parked in a parking lot, a lot of low-height three-dimensional objects exist in the parking lot. Even in this case, in the embodiment, each of the three-dimensional objects may be determined with high accuracy, and each of the determined three-dimensional objects is displayed on the monitor 12 so as to be clearly specified.

<Modification 1>

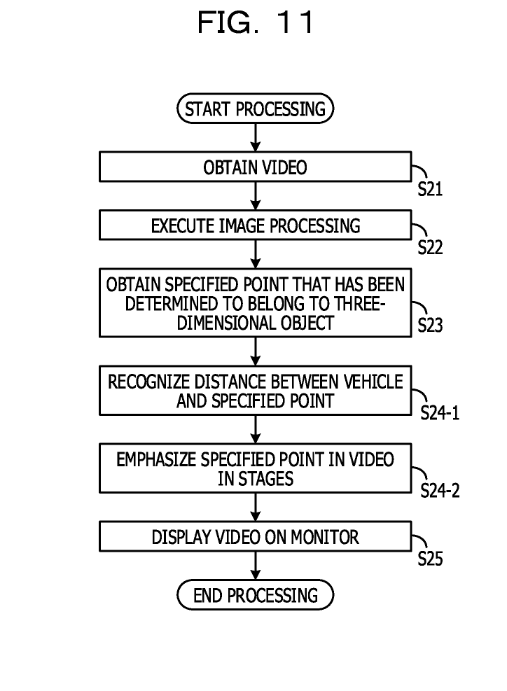

A modification 1 is described below. FIG. 11 is a flowchart illustrating an example of display processing in the modification 1. In the flowchart of FIG. 11, the processing of Steps S21 to S23, and S25 is the same as the flowchart of FIG. 8.

The image processing unit 26 recognizes a distance between the vehicle and a specified point, based on a video that has been subjected to the image processing (Step S24-1). In addition, the image processing unit 26 emphasizes the specified point in stages based on the distance between the vehicle and the specified point (Step S24-2).

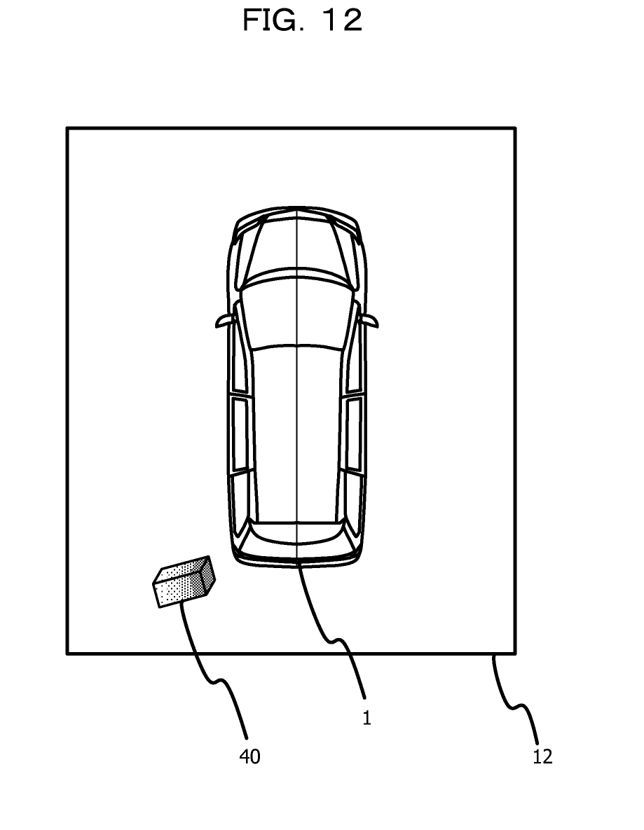

FIG. 12 is a diagram illustrating an example of a video displayed on the monitor 12. The three-dimensional object 40 in the monitor 12 is displayed so as to be emphasized in stages. In the three-dimensional object 40, a specified point close to the vehicle 1 is displayed so that the emphasis of the display is increased, and a specified point far from the vehicle 1 is displayed so that the emphasis of the display is reduced. In the example of FIG. 12, as the degree of the emphasis display is increased, the shaded portion becomes darker.

As a result, the driver of the vehicle 1 may visually recognize a portion in the three-dimensional object 40, which is the closest to the vehicle 1. For example, when the driver parks the vehicle 1, the driver may park the vehicle 1 so that the vehicle 1 does not come in contact with the three-dimensional object 40.

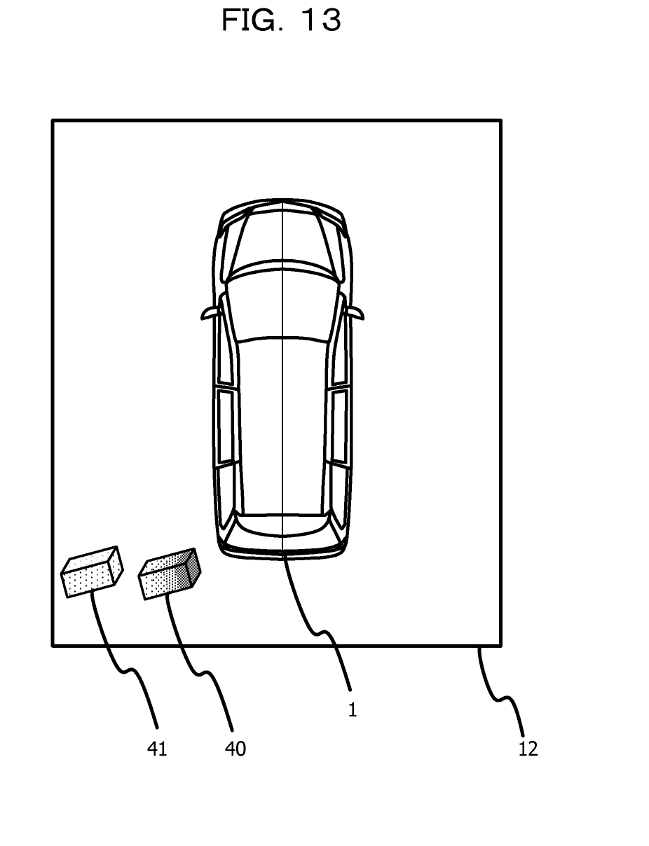

FIG. 13 is a diagram illustrating an example in which a specified point that belongs to a three-dimensional object 40 (hereinafter, referred to as a first three-dimensional object 40) and a specified point that belongs to a three-dimensional object 41 (hereinafter, referred to as a second three-dimensional object 41) are displayed on the monitor 12. The first three-dimensional object 40 is located close to the vehicle 1, so that the specified point is displayed so as to be emphasized.

Thus, as illustrated in the example of FIG. 13, even when the first three-dimensional object 40 and the second three-dimensional object 41 are low-height three-dimensional objects, the specified point that belongs to the three-dimensional objects is displayed so as to be emphasized, so that the driver may easily recognize the first three-dimensional object 40 and the second three-dimensional object 41.

Specifically, the specified point that belongs to the first three-dimensional object 40 that is close to the vehicle 1 is displayed so that the emphasis of the display is increased, and the specified point that belongs to the second three-dimensional object 41 that is far from the vehicle 1 is displayed so that the emphasis of the display is reduced. Therefore, the driver of the vehicle 1 may easily recognize one of the first three-dimensional object 40 and the second three-dimensional object 41, which is closer to the vehicle 1.

<Modification 2>

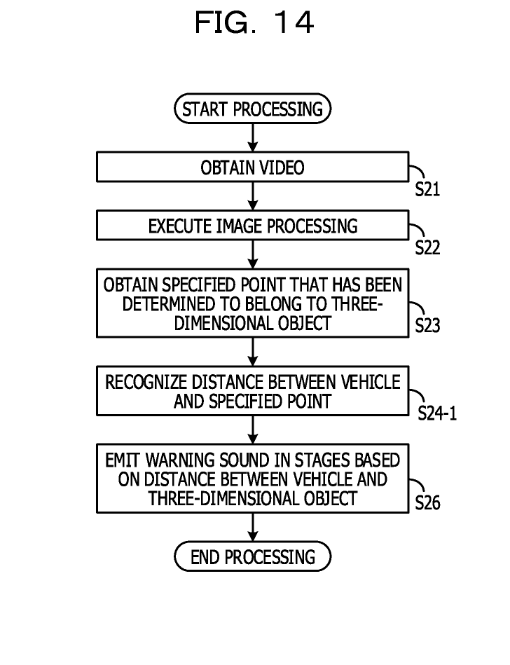

A modification 2 is described below. FIG. 14 is a diagram illustrating an example of warning processing in the modification 2. The processing of Steps S21 to S24-1 in FIG. 14 is the same as the processing in the modification 1. The warning unit 24 recognizes a distance between the vehicle and the three-dimensional object, based on the determination result of the determination unit 23 (Step S24-1).

The warning unit 24 controls the warning sound to be emitted in stages, based on the distance between the vehicle and the three-dimensional object (Step S26). For example, when the distance between the vehicle and the three-dimensional object is not so small, the warning unit 24 controls the speaker 14 to emit the warning sound having the low volume. As a result, the driver of the vehicle 1 may recognize the presence of a low-height three-dimensional object such as a curb.

When the distance between the vehicle and the three-dimensional object is small, the warning unit 24 controls the speaker 14 to emit the warning sound having the high volume. As a result, the driver of the vehicle 1 may recognize that the low-height three-dimensional object such as the curb exists at a position in the vicinity of the vehicle 1.

In the above-described various examples, the driver of the vehicle 1 is caused to visually recognize a low-height three-dimensional object by causing the three-dimensional object to be displayed on the monitor 12, but as described in the modification 2, the driver of the vehicle 1 may be caused to recognize the low-height three-dimensional object by sound.

<Example of a Hardware Configuration of a Driving Support Device>

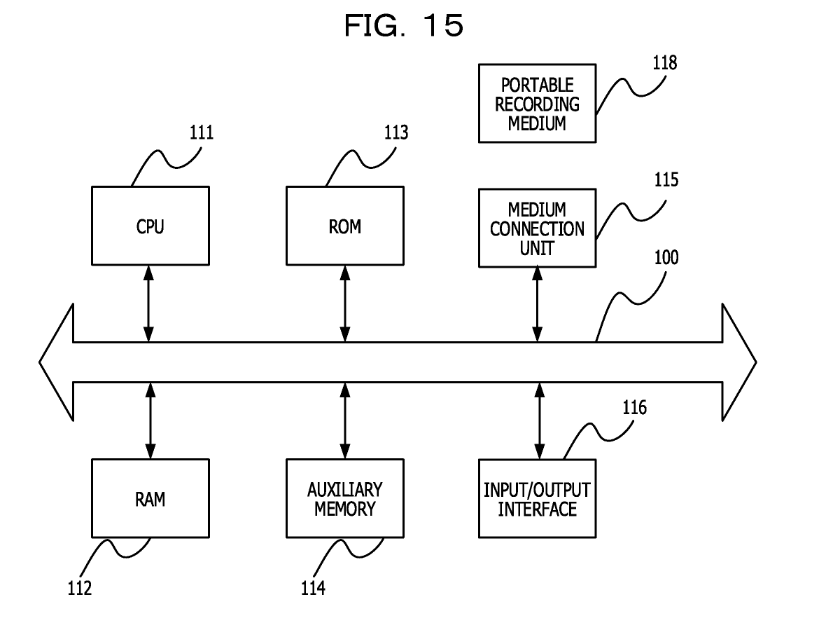

An example of a hardware configuration of a driving support device 11 is described below with reference to FIG. 15. As illustrated in the example of FIG. 15, a central processing unit (CPU) 111, a random access memory (RAM) 112, a read only memory (ROM) 113, an auxiliary memory 114, a medium connection unit 115, and an input/output interface 116 are coupled to a bus 100.

The CPU 111 is a certain processing circuit. The CPU 111 executes a program that has been deployed to the RAM 112. As the program to be executed, a program used to execute the processing in the embodiments may be applied. The ROM 113 is a nonvolatile storage device that stores the program that is to be deployed to the RAM 112. The function of each of the units of the three-dimensional object detection device 10 may be achieved by the CPU 111.

The auxiliary memory 114 is a storage device that stores various pieces of information, and for example, a hardware disk drive, a semiconductor memory, or the like may be applied as the auxiliary memory 114. The medium connection unit 115 is provided so as to be coupled to a portable recording medium 118. The input/output interface 116 is an interface used to input and output data to and from external equipment. As the external equipment, for example, there are the camera 2, the monitor 12, and the like.

As the portable recording medium 118, a portable memory or an optical disk (for example, a compact disk (CD), a digital versatile disk (DVD), or the like) may be applied. The program used to execute the processing in the embodiments may be recorded to the portable recording medium 118.

All of the RAM 112, the ROM 113, and the auxiliary memory 114 are examples of computer-readable tangible storage mediums. The tangible storage medium does not include a temporary medium such as signal carrier waves.

### Other Embodiments

The technology discussed herein is not limited to the above-described embodiments, and various configurations or embodiments may be taken within the scope not departing from the gist of the technology discussed herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A detection system that detects a three-dimensional object on a reference surface, the detection system comprising:
a ranging device configured to measure a distance and a direction to an object including the three-dimensional object; and
a processor configured to
obtain ranging data from the ranging device, the ranging data being an aggregation of three-dimensional points indicating a position of the object, which are defined from the distance and the direction,
calculate, based on the ranging data, a change amount in a height direction between a first point from among the aggregation of three-dimensional points and each of surrounding points of the first point,
determine whether the first point is included in one or more points corresponding to the three-dimensional object, based on a difference between the change amounts, and
output a result of a determination.

2. The detection system according to claim 1, wherein
the difference is an absolute value of a total of the change amounts.

3. The detection system according to claim 2, wherein
the processor is configured to determine that the first point is included in one or more points corresponding to the three-dimensional object when the absolute value of the total of the change amounts is equal to or greater than a threshold value.

4. The detection system according to claim 1, wherein
the ranging device is configured to measure the ranging data at certain intervals.

5. The detection system according to claim 4, wherein
the processor is configured to obtain the ranging data from the ranging device at the certain intervals, and determine whether the first point is included in one or more points corresponding to the three-dimensional object, based on the three-dimensional points included in a plurality of pieces of temporally successive ranging data.

6. The detection system according to claim 1, wherein
the change amount in the height direction is a tilt based on a coordinate in a horizontal plane and a coordinate in a vertical direction in a coordinate system of a three-dimensional space, by which a coordinate system of the ranging device is replaced for the first point and for each of the surrounding points.

7. The detection system according to claim 1, wherein
the surrounding points are four points that are adjacent to the first point in a vertical direction and a horizontal direction in the coordinate system of the ranging device.

8. The detection system according to claim 1, wherein
the reference surface is a road surface,
the object exists within a range in which the ranging device is allowed to perform measurement from vehicle installing the ranging device, and
the three-dimensional object is an object that protrudes from the road surface in a vertical direction, which is included in the object.

9. The detection system according to claim 8, further comprising:
an imaging device installed in the vehicle and capturing a video of a surrounding of the vehicle; and
a display device provided in the vehicle, that displays the video captured by the imaging device, and displays warning information based on the determined result.

10. The detection system according to claim 9, wherein
the processor is configured to obtain the video captured by the imaging device, and control the display device to display the warning information obtained by emphasizing a portion corresponding to the first point in the video, when it is determined that the first point is included in one or more points corresponding to the three-dimensional object.

11. A detection method executed by a processor configured to detect a three-dimensional object on a reference surface, the detection method comprising:
obtaining ranging data from a ranging device that measures a distance and a direction to an object including the three-dimensional object, the ranging data being an aggregation of three-dimensional points indicating a position of the object, which are defined from the distance and the direction;
calculating, based on the ranging data, a change amount in a height direction between a first point from among the aggregation of three-dimensional points and each of surrounding points of the first point;
determining whether the first point is included in one or more points corresponding to the three-dimensional object, based on a difference between the change amounts; and
outputting a result of a determination.

12. The detection method according to claim 11, wherein
the difference is an absolute value of a total of the change amounts.

13. The detection method according to claim 12, wherein
the determining determines that the first point is included in one or more points corresponding to the three-dimensional object when the absolute value of the total of the change amounts is equal to or greater than a threshold value.

14. The detection method according to claim 11, wherein
the ranging device is configured to measure the ranging data at certain intervals.

15. The detection method according to claim 14, further comprising:
obtaining the ranging data from the ranging device at the certain intervals, and
wherein the determining determines whether that the first point is included in one or more points corresponding to the three-dimensional object, based on the three-dimensional points included in a plurality of pieces of temporally successive ranging data.

16. The detection method according to claim 11, wherein
the change amount in the height direction is a tilt based on a coordinate in a horizontal plane and a coordinate in a vertical direction in a coordinate system of a three-dimensional space, by which a coordinate system of the ranging device is replaced for the first point and for each of the surrounding points.

17. The detection method according to claim 11, wherein
the surrounding points are four points that are adjacent to the first point in a vertical direction and a horizontal direction in the coordinate system of the ranging device.

18. The detection method according to claim 11, wherein
the reference surface is a road surface,
the object exists within a range in which the ranging device is allowed to perform measurement from vehicle installing the ranging device, and
the three-dimensional object is an object that protrudes from the road surface in a vertical direction, which is included in the object.

19. A non-transitory storage medium storing a detection program for detecting a three-dimensional object on a reference surface, the detection program causing a computer to:
obtain ranging data from a ranging device that measures a distance and a direction to an object including the three-dimensional object, the ranging data being an aggregation of three-dimensional points indicating a position of the object, which are defined from the distance and the direction,
calculate, based on the ranging data, a change amount in a height direction between a first point from among the aggregation of three-dimensional points and each of surrounding points of the first point,
determine whether the first point is included in one or more points corresponding to the three-dimensional object, based on a difference between the change amounts, and
output a result of a determination.
